(19) United States
(12) Patent Application Publication
(10) Pub. No.: US 2021/0108828 A1
(43) Pub. Date: Apr. 15, 2021

(54) MAGNETIC INDUCTION FURNACE, COOLER OR MAGNETOCALORIC FLUID HEAT PUMP WITH VARIED CONDUCTIVE PLATE CONFIGURATIONS

(71) Applicant: Heat X, LLC, Auburn Hills, MI (US)

(72) Inventor: Miguel A. Linares, Bloomfield Hills, MI (US)

(21) Appl. No.: 17/066,638

(22) Filed: Oct. 9, 2020

Related U.S. Application Data
(60) Provisional application No. 62/912,679, filed on Oct. 9, 2019.

(51) Int. Cl. F24H 3/04; H05B 6/10; F24H 9/00; H05B 3/40; F04D 29/28; F04D 29/42; F04D 25/08

(52) U.S. Cl. CPC F24H 3/0405; H05B 6/108; H05B 6/109; F24H 9/0063; H05B 3/40; F24H 2250/06; F04D 29/4206; F04D 25/08; F24H 2250/08; F24H 2250/02; F04D 29/281

(57) ABSTRACT

A fluid conditioning system having a housing within a fluid inlet and a fluid outlet. A rotating shaft extends within the housing and secures a conductive component exhibiting fluid flow redirecting vanes for communicating an inlet fluid flow with an outlet fluid flow. Magnets or electromagnets are arranged in a stationary array within the housing in proximity to the rotary conductive component and, upon rotating the conductive component relative to the magnetic plates, thermal conditioning of the fluid flow is generated from creation of high frequency oscillating magnetic fields and which is conducted through the rotating component for outputting through the outlet of the housing. Peltier or other thermoelectric generator elements can be incorporated into the housing. The conductive components or plates can include any of a number multi-metal/multi-alloy plate configurations.

### CROSS REFERENCE TO RELATED APPLICATIONS

The present application claims the priority of U.S. Ser. No. 62/912,679 filed Oct. 9, 2019, the contents of which are incorporated by reference.

### FIELD OF THE INVENTION

The present invention relates generally to an electromagnetic or magnetic induction furnace, cooler or magnetocaloric fluid heat pump. More specifically, the present invention discloses a magnetic induction furnace or cooler with varied rotating conductive plate configurations arranged in alternating fashion with either of a magnet or electromagnetic fixed array configured within a blower style housing. A side air intake is configured within the housing and operates to draw ambient air into the housing interior for heating and redirection via the conductive plates through a forward outlet.

### BACKGROUND OF THE INVENTION

The phenomena of magnetic or electromagnetic induction heating is well known in the prior art by which heat is generated in an electrically conductive object by the generation of eddy currents, also called Joule heating. The typical induction heater includes an electronic oscillator which passes a high frequency alternating current through an electromagnet. The eddy currents flowing through the resistance of a conductive metal placed in proximity to the magnet/electromagnet in turn heat it. Put another way, the eddy currents result in a high-frequency oscillating magnetic field which causes the magnet's polarity to switch back and forth at a high-enough rate to produce heat as byproduct of friction.

One known example of a prior art induction heating system is taught by the electromagnetic induction air heater of Garza, US 2011/0215089, which includes a conductive element, a driver coupled to the conductive element, an induction element positioned close to the conductive element, and a power supply coupled to the induction element and the driver. Specifically, the driver applies an angular velocity to the rotate the conductive element around a rotational axis. The power supply provides electric current to the induction element to generate a magnetic field about the induction element such that the conductive element heats as it rotates within the magnetic field to transfer heat to warm the cold fluid flow streams. The fluid flow streams are circulated about the surface of the conductive element and directed by the moving conductive element to generate warm fluid flow streams from the conductive element.

Also referenced is the centrifugal magnetic heating device of Hsu 2013/0062340 which teaches a power receiving mechanism and a heat generator. The power receiving mechanism further includes a vane set and a transmission module. The heat generator connected with the transmission module further includes a centrifugal mechanism connected to the transmission module, a plurality of bases furnished on the centrifugal mechanism, a plurality of magnets furnished on the bases individually, and at least one conductive member corresponding in positions to the magnets. The vane set is driven by nature flows so as to drives the bases synchronically with the magnets through the transmission module, such that the magnets can rotate relative to the conductive member and thereby cause the conductive member to generate heat.

### SUMMARY OF THE PRESENT INVENTION

The present invention discloses a fluid conditioning system including a housing within a fluid inlet and a fluid outlet, a rotating shaft extending within the housing and securing a conductive component exhibiting fluid flow redirecting vanes for communicating an inlet fluid flow with an outlet fluid flow. Either of magnets or electromagnets are arranged in a stationary array within said housing in proximity to said rotary conductive component. Upon rotating the conductive component relative to the magnetic plates, thermal conditioning of the fluid flow being generated from creation of high frequency oscillating magnetic fields and being conducted through said rotating component for outputting through the outlet of said housing.

Additional features include the provision of the fluid flow redirecting vanes associated with the rotating conductive component further including a first inner plurality of circumferentially arrayed vanes and a second outer plurality of circumferentially arrayed vanes. The fluid flow regulating baffles are further configured to disrupt continuous movement of airflow within the rotating conductive component during thermal conditioning and prior to exiting through the outlet.

The rotating conductive component may also include first and second spaced apart plates, these alternating with the magnets/electromagnets. The rotating conductive component may further be constructed of a first thermally conductive material and include a superheated core portion arranged closest to the magnets/electromagnets.

The core portion further includes a plurality of inserts of a second thermally conductive material interspersed with the first thermally conductive material in order to promote the occurrence of eddy currents in order to facilitate the creation of the high frequency oscillating magnetic fields. The fluid inlet further includes a pair of opposite side located inlets, a pair of end intake fluid warming component arranged in proximity to the side inlets prior to communicating the fluid flow to the spaced apart plates.

Alternatively, the fluid inlet further includes a plurality of slot shaped inlets extending circumferentially around a middle location of the housing, with a center intake fluid warming component arranged in proximity to the slot shaped inlets prior to communicating the fluid flow to the spaced apart plates. The first thermally conductive material further can include any metal or alloy, ceramic or any metal-ceramic composite material, graphite or combination thereof.

The second thermally conductive material further comprising any metal or alloy, ceramic or any metal-ceramic composite material or graphite or combination of such conductive materials. The rotating conductive may also include a core portion opposing the magnet/electromagnet array, the conductive component further including a second axial portion secured to the core portion.

Without limitation, the fluid flow redirecting vanes can further include opposing pluralities of the vanes arranged upon each of the core portion and the axially secured portion. The core portion may also include any of a magnetic flux heated metal or combination of metals. A plurality of heat sink inducing ribs may be integrated into the core portion in proximity to the fluid inlet. Other features include elongated and thermal resistor coils extending in any of horizontally, vertically, perimetral, or radial distributing fashion within the housing and across the core portion and axially secured portion, the coils following any of circumferential, polygonal, or other geometrical shape.

A combined layering of electric induction heating and magnetic induction heating aspects can be provided to accelerate a pre-heating operation. Other features include the fluid flow regulating baffles extending around the fluid flow redirecting vanes. Peltier elements or other thermoelectric generators can also be incorporated into the housing. Finally, the housing can include a pseudo cylindrical shape supported upon a pedestal portion.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 a perspective view of an electromagnetic or magnetic induction furnace, cooler or magnetocaloric fluid heat pump according to a first embodiment of the present invention;

FIG. 2 is a linear cutaway of FIG. 1 and illustrating a dual rotating conductive plate array in combination with alternating fixed magnets/electromagnets;

FIG. 3 is an illustration similar to FIG. 2 of a further variant of the present invention and depicting end intake heat sinks in substitution of the end intake air warmers of FIG. 2;

FIGS. 4A-4D present a series of cutaway sectional views of alternate versions of a core portion of the rotating conductive plates taken along line 4-4 of FIG. 2 and which can include varying patterns of materials, bi-materials or multi-materials designs, such materials can be metals or alloys, ceramics or any metal ceramic composite materials;

FIG. 5 is a perspective view of an electromagnetic or magnetic induction furnace, cooler or magnetocaloric fluid heat pump according to a second embodiment of the present invention;

FIG. 6 is a linear cutaway of FIG. 5 and illustrating an inner rotating conductive plate array in combination with an outer opposing and annular positioned fixed magnet/electromagnet array;

FIG. 7 is a rotated perspective of FIG. 6 similar to the orientation of FIG. 5 and showing a variation of a heater core associated with the rotating conductive plate in comparison to that shown in FIG. 6 for increasing surface area exposure to the ambient intake air in order to enhance heating;

FIG. 8 is a perspective illustration of an electromagnetic or magnetic induction furnace, cooler or magnetocaloric fluid heat pump similar in respects to FIG. 5 and according to a third embodiment of the present invention;

FIG. 9 is a perspective cutaway view similar to as shown in FIG. 7 and depicting the central rotating conductive plate surrounded by the fixed magnet/electromagnet array, the conductive plate including each of an outer radial magnetic flux heated metal/alloy or combination of metals/alloys in combination with an inner radial heat sink arrangement of fan/ribs for heating the intake ambient air;

FIG. 10 is an exploded view of the first and second assembleable components of the conductive plate of FIG. 9 and showing the nesting arrangement established between the inner and outer fluid redirecting vane patterns associated with each component;

FIG. 11 is a rotated exploded perspective of FIG. 10 and further depicting from another angle the nesting arrangement established between the inner and outer fluid redirecting vane patterns associated with each component;

FIG. 12 is a partially cutaway perspective of an electromagnetic or magnetic induction furnace, cooler or magnetocaloric fluid heat pump according to a fourth embodiment of the present invention and depicting an outer array of circulation baffles for assisting in controlling both an outlet velocity and convection heat profile of the fluid within the housing;

FIG. 13 is a rotated perspective as compared to FIG. 12 and depicting a modified variant incorporating a plurality of circumferentially arrayed resistor coils for providing additional, typically pre-heating, prior to the conductive plates achieving a desired thermal profile temperature;

FIG. 14 is a rotated perspective of FIG. 13 with additional components removed and showing a configuration of Peltier elements or other thermoelectric generators incorporated into the housing proximate the fixed magnetic/electromagnetic array and the superheated core portion of the rotating thermally conductive component, such including thermoelectric coolers (TEC's) for transferring heat from one side to another depending on the direction of an applied electrical current;

FIG. 15 a cutaway perspective of an electromagnetic or magnetic induction furnace, cooler or magnetocaloric fluid heat pump according to a fifth embodiment; and

FIGS. 16A-16C present a series of cutaway sectional views of alternate versions of a core portion of the rotating conductive plates of taken along line 16-16 of FIG. 15 and which depict varying patterns of bi-metal/bi-alloys or multi-metal/multi-alloys designs.

### DETAILED DESCRIPTION OF THE PREFERRED EMBODIMENTS

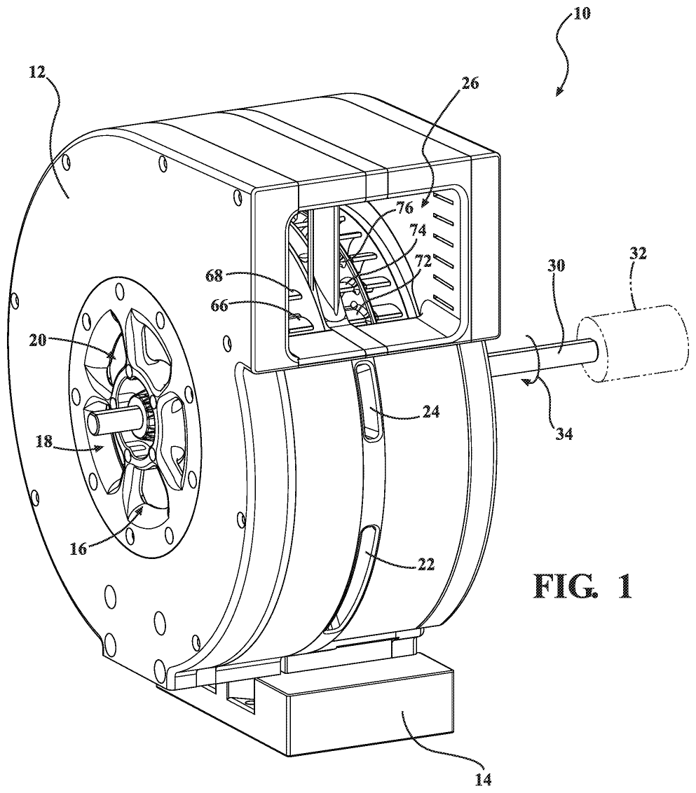

With reference to the attached illustrations, the present invention discloses in one non-limited application a magnetic or electromagnetic induction furnace, cooler or magnetocaloric fluid heat pump, an example of which is illustrated at 10 in FIG. 1. In either version, the magnetic or electromagnetic induction furnace, cooler or magnetocaloric fluid heat pump incorporates a combination circular/rotary and vane shaped electrically conductive plate, such as which is integrated into a central elongated and rotating element for simultaneously inductive heating the proximate located magnetic or electromagnetic plates as well as redirecting the heated/cooled fluid out of a blow shaped housing or cabinet. As will be further described and with additional reference to potential alternate variants, the magnetic or electromagnetic induction furnace or cooler can be reconfigured as any of a magnetocaloric fluid heat pump, active magnetic regenerator, magnetic/magnetocaloric refrigerator, or magnetic/electromagnetic air conditioner.

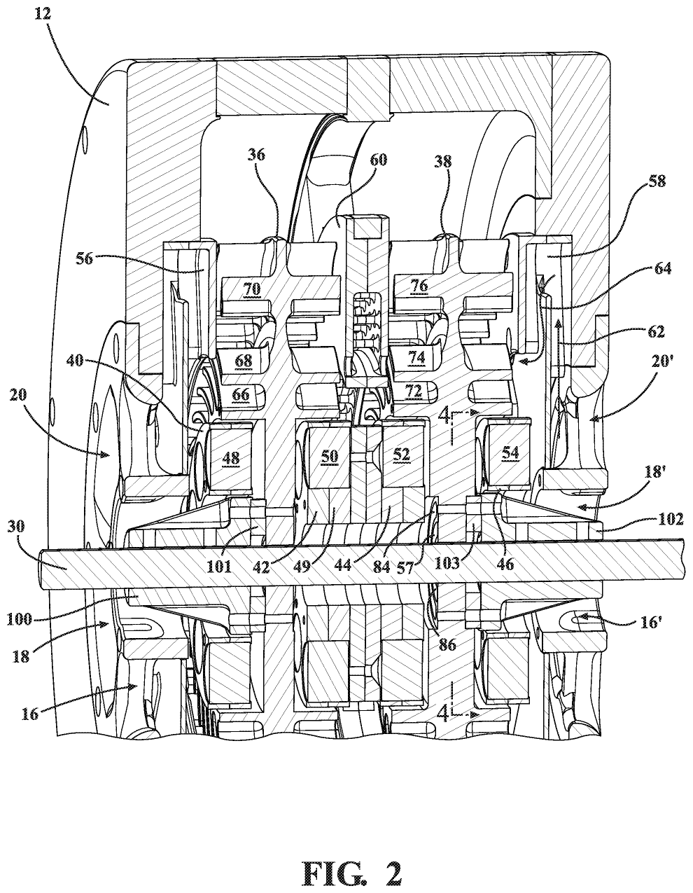

FIG. 1 a perspective view, generally at 10, of an electromagnetic or magnetic induction furnace, cooler or magnetocaloric fluid heat pump according to a first embodiment of the present invention. The assembly includes a three-dimensional housing arranged in a generally blower shape with a generally annular shaped body 12 and a pedestal base support 14. A series of ambient air intake locations are provided at each of side or end locations (one of which is depicted at 16, 18, 20, et seq.) as well as extending in circumferentially spaced manner (further at 22, 24, et seq.). A heated fluid outlet is further depicted at 26 and, as will be further described in reference to FIGS. 2-4D, issues a heated airflow generated by the rotating conductive plates in combination with a fixed magnet or electro-magnet array. A central shaft 30 is depicted which extends through the housing and can be rotated by a motor or other rotary inducing input generally represented at 32 as well as any other rotating input for turning the shaft such as in direction 34 for directing the heated air through the outlet 26.

FIG. 2 is a linear cutaway of FIG. 1 and illustrating a dual rotating conductive plate array, see at 36 and 38, which are provided in combination with magnetic/electromagnetic supporting plates 40, 42, 44 and 46. Each of the plates 40-46 are secured to locations within the housing and each further exhibits a central aperture (see at 49 for plate 42 and at 51 for plate 44) through which the rotating shaft 30 extends.

As further shown, the plates 40-46 each further incorporate a circumferential spaced plurality of magnets or electromagnets, respectively shown at 48, 50, 52 and 54. Also depicted are an additional opposite side wall array of ambient intake openings 16′, 18′, 20′, et seq. which correspond with those identified in FIG. 1. Without limitation, the configuration and material selection for each of the magnetic and electromagnetic plates can be selected from any material not limited to rare earth metals and alloys and which possesses properties necessary to generate adequate oscillating magnetic fields for inducing magnetic heating, such again resulting from the ability to either maintain or switch the magnet polarity at a sufficiently high rate in order for the generated friction to create the desired heat/cold profile. The conductive plates can be constructed of a ferromagnetic, ferromagnetic, antiferromagnetic, paramagnetic or diamagnetic material and, as understood, do not generate magnetic fields but are based on electromagnetic or magnetic induction such that they create eddy currents.

The conductive plate array illustrates the rotating plates 40 and 42 separated by a pair of outer end intake components 56 and 58 in combination with a central intake warmer component 60. The end intake components 56/58 each exhibit a reverse angled redirection passageway, see at 62 and 64 for end intake component 58, for preheating the intake fluid/air prior to the same being redirected by the rotating conductive plates 36/38.

Each of the conductive plates further incorporates a plurality of arcuate shaped redirecting vanes, see at 66, 68, 70, et seq. for plate 36 and further at 72, 74, 76, et seq., and which are depicted as arranged in circumferentially spaced and projecting fashion from each opposite surface of each of the plates 36/38. In combination with the other features of the plates 36/38, the vanes operate during rotation of the conductive plates to influence (push) the inductive heated air generated in the spaces between the magnet/electromagnet array and the rotating conductive plates resulting from the frictional heat generating forces resulting from varying/oscillating magnetic fields for delivery through the outlet 26 of the blower style housing 12.

In this manner, the core of the individual rotating plates 36 and 38 are caused to become heated (or superheated) to a desired temperature due to their positioned relationship with pairs of the individual magnet/electromagnet supporting plates 40/42, and 44/46, the cores in turn heating the intake fluid/air for concurrent redirection via the circumferential arranged vanes through the outlet 26.

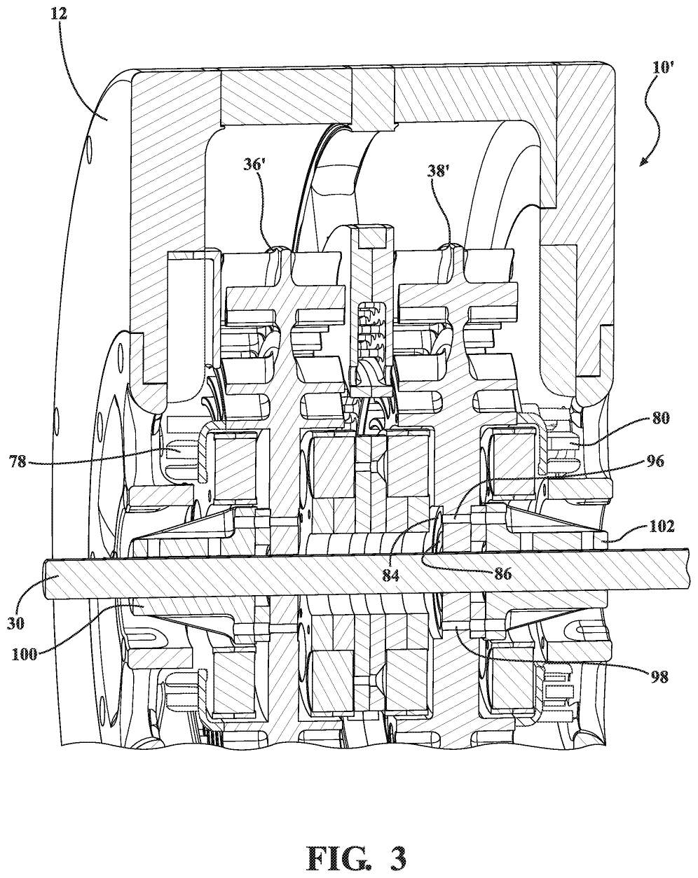

FIG. 3 is an illustration similar to FIG. 2 of a further variant 10′ of the present invention and depicting end intake heat sinks, see at 78 and 80, which are incorporated into modified rotating conductive plates 36′/38′ in substitution for the end intake air warmers 56/58. The configuration of FIG. 3 is otherwise similar to that depicted in FIG. 2 and by which the end intake heat sinks 78/80, each of which as shown including a plurality of air directing and diffusing components, operate to pre-heat the intake air before being redirected to the superheated core of the rotating conductive plates 36′/38′ where they receive additional heating via convection resulting from the inductive heating occurring in the spaces between the magnets/electromagnets and the rotating/redirecting plates, the vane arrays associated with each of conductive plates 36′/38′ further causing the heated air to be redirected through the outlet 26 (again FIG. 1).

In this fashion, the varying electromagnetic fields inductive heat the magnetic or electromagnetic plates owing to the alternating fields generated by the rotation of the proximate located metallic conductive plates 36′/38′, as well as the air or other fluid inducing and redirecting architecture of the conductive plates operating to concurrently draw outwardly and redirect the air or other fluid from the side or central (such as ambient or cold) fluid inlets identified in FIG. 1, across the magnetic or electromagnetic plates in conductive heating fashion (or alternatively cooling fashion if using electromagnets instead of permanent magnets during the demagnetization of the conductive plates to absorb heat from the fluid that is recirculated), with the conditioned fluid being communicated out the blower exit 26.

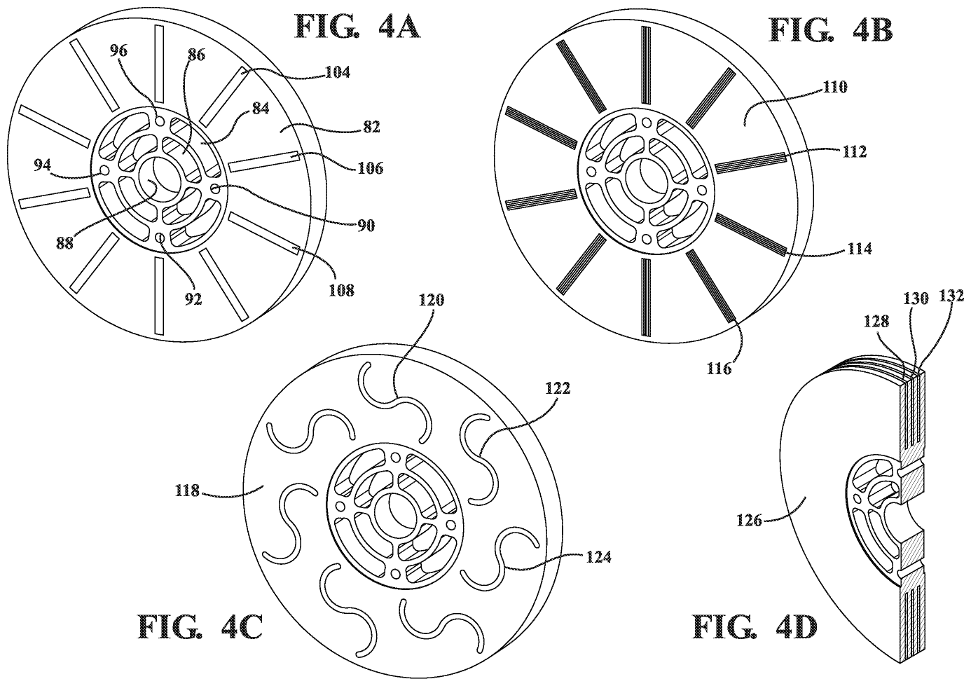

With reference now to FIGS. 4A-4D, presented are a series of cutaway sectional views of alternate versions of a core portion of the rotating conductive plates taken along line 4-4 of FIG. 2. The core portions each can include varying patterns of materials, bi-materials or multi-materials designs such materials including any suitable metal or alloy, ceramic or any metal-ceramic composite material or graphite or any combination of such conductive materials.

With reference initially to FIG. 4A, a first example is depicted of a core portion of a rotating conductive plate (again either 36/38 as shown in FIG. 2 or 36′/38′ in the modification of FIG. 3). A main circular body 82 is depicted which surrounds a plurality of additional convective inducing heat passageways 84/86 (these also shown in FIGS. 2-3). Also shown is central aperture 88 which corresponds to the securing location to the central extending shaft 30. Additional aperture locations 90, 92, 94 and 96 are arranged around an inner proximate circumference of the core portion in FIG. 4A and further correspond to aligning locations within end mounted support portions 100 and 102 (see FIGS. 1 and 2) for receiving such as mounting pins or the like (not shown) for assisting in mounting and supporting each of the rotating conductive plates to the rotatable shaft 30. To this end, additional separating/insulating members 101 and 103 are provided between the core portion associated with each rotating conductive plate and the end mounted support portions 100/102, as again shown in each of FIGS. 2 and 3, in order to mount the pairings of the end portions and insulating members (see again at 100/101 and 102/103) against opposite exterior facing sides of the core portions to assist in limiting heat loss and in order to maximize transfer of the inductive generated heat via the redirected fluid flows created by rotation of the conductive plates.

FIG. 4A further shows an arrangement of additional and varied metallic inserts, these depicted at 104, 106, 108, et seq. arranged in radial extending and circumferential spaced fashion about the disk shape of the core portion. Without limitation, the core portion for each conductive plate can be initially formed with the inserts or can be machined with pockets which receive the inserts in a post fabricating process.

The inserts can further, without limitation, exhibit an elongated three dimensional rectangular shape such as in bar form and, in contrast to the main body of the core portion, can be provided as a separate material. In one non-limiting configuration, the main body can include any construction, with the inserts not-limited to any additional conductive or rare earth material.

In operation, the core portion of each of the plates 36/38 (FIGS. 2) and 36′/38′ (FIG. 3) provide a maximum heated (or superheated) zone for convective transferring of heat to the intake and redirected fluid or airflows in order to maximize a desired thermal profile through the housing outlet 26 (FIG. 1). This can again include the enhancement of the eddy currents being generated in order to maximize the created oscillating fields and resultant frictional/inductive heat between the rotating plates and magnets/electromagnets.

FIG. 4B depicts an alternate variant 110 of a conductive plate core portion and which includes a similar construction to FIG. 4A with the exception of a redesigned arrangement of radially projecting and circumferentially spaced inserts depicted at 112, 114, 116, et seq. which are similarly integrated into the main body construction of the core portion. The inserts 112, 114, 116, et seq. can include individual pluralities of stacked elongated plates (as opposed to the one piece inserts in FIG. 4A) which are integrated into the main body of the core portion and can again be selected from any suitable and varied thermally conductive metal as described above in order to enhance generation of eddy currents and, accordingly, maximizing inductive heating/magnetocaloric cooling.

FIG. 4C illustrates a further variant of core portion 118 depicting a plurality of counter-arcuate bended (“S”) inserts 120, 122, 124, et seq., arranged around the circumference of the core portion. FIG. 4D illustrates a further reconfigured core portion 126 which, as depicted in cutaway section, reveals a plurality of ring shaped inserts 128, 130 and 132 integrated into the core portion in a multi-layered fashion and, in operation, for providing a further varied inductive heating profile resulting from the generation of eddy currents at the superheated core location of each conductive plate. In each instance, the location where the eddy current/joule currents take place also functions as a fan/fluid propeller for influencing fluid flow through the housing outlet.

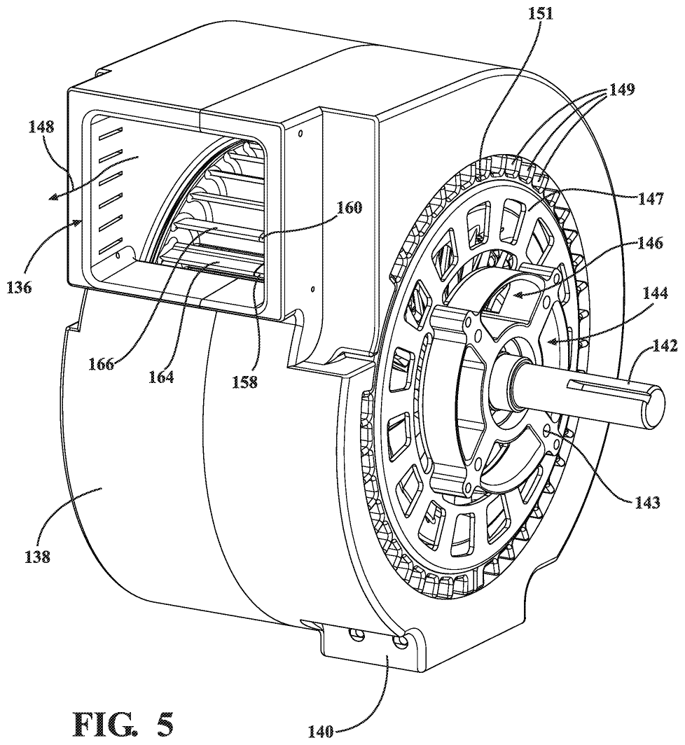

Proceeding to FIG. 5, a perspective view is generally shown at 136 of an electromagnetic or magnetic induction furnace, cooler or magnetocaloric fluid heat pump according to a second embodiment of the present invention. For purposes of the remaining description, features in the additional embodiments which are common to those previously described will be generally referenced with focus given to the unique structure associated with each such embodiment.

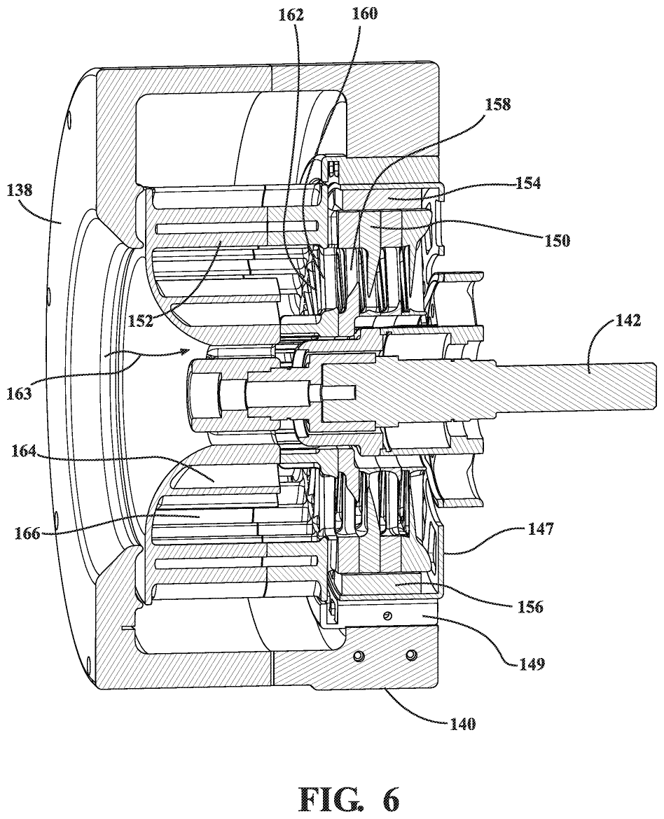

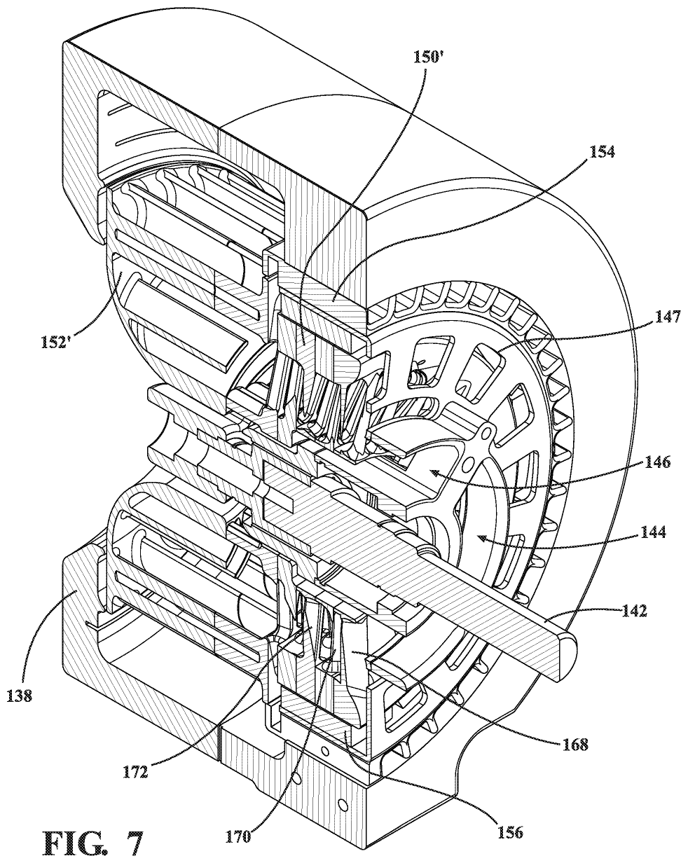

As with FIG. 1, the embodiment 136 in FIG. 5 again includes a suitable blower shaped body 138, such as which is supported upon a pedestal base 140, and including a drive shaft 142 for powering the interior supported and rotating conductive components (see as described in reference to FIGS. 6-7). An associated cover plate 143 secured to the side of the housing 138 receives the centrally supported shaft 142 and further includes side inlet locations 144, 146, et seq. for receiving ambient air/fluid. A disk shaped grill portion 147 in turn supports the cover plate 143, with a plurality of outer diffusing fins 149 projecting from an outer annular support 151 which supports the grill portion 147 (see again FIGS. 6-7). Also similar to FIG. 1 is a heated/cooled air or fluid outlet location 148 depicted in FIG. 5.

Referring now to FIG. 6, a linear cutaway is shown of FIG. 5 and illustrating an inner rotating conductive plate array (see joined components including a rotating core 150 and an outer mating component 152), these collectively defining a rotating conductive turbine style fan which, in combination with an outer opposing and annular positioned fixed magnet/electromagnet array for creating the desired inductive heating or magnetocaloric cooling, the magnets/electromagnets further represented at 154 and 156, et seq., positioned around the core 150. Both the core 150 and mating component 152 include an arrangement of fluid redirecting vanes, see as shown at 158, 160, 162 et. seq. for the core portion 150 and further at 160, 662, et seq. for the mating component 152 such that rotation of the heater core 150 relative to the proximately positioned magnets/electromagnets 154, 156, et seq. results in the intake air being rapidly heated in the illustrated application owing to the oscillating magnetic inductive fields generated. A separate inlet is further represented by arrow 163 in FIG. 6 which is opposite to the inlets shown in FIG. 5.

The construction of the rotating components 150/152 is further such that they can exhibit different thermal conductive material properties (similar to the discussion of FIGS. 4A-4D) in order to enhance the generation of desired eddy currents and, consequently, the oscillating fields resulting in inductive heating in the spaces between the magnets/electromagnets and the core.

FIG. 7 further provides a rotated perspective of FIG. 6, similar to the orientation of FIG. 5, and showing a variation of a heater core 150′ and axially joined mating component 152′ associated with the rotating conductive plate, these in comparison to that shown in FIG. 6 for increasing surface area exposure to the ambient intake air in order to enhance heating. The modified core 150′ is further reflected by the additional baffling structure, see at 168, 170, 172, et seq., and which, in combination with the grill 147 and outer diffuser fins 149 operate to slow the flow of the intake air through the areas proximate the core at which maximum heat transfer may occur and prior to the heated or cooled air or fluid exiting through outlet 148 in FIG. 5.

The axially joined mating component 152′, similar to that depicted in FIG. 6, provides additional redirection vanes which, upon rotation, provide an incremental additional degree of heat transfer and fluid flow redirection through the outlet 148. Without limitation, the baffling and vane structure of both the core and laterally joined and mating components can be modified to vary the desired heat profile delivered by the blower style inductive heater and this can further include the additional of any type of thermostat or other controller structure for modifying a speed of rotation by the shaft of the conductive fan.

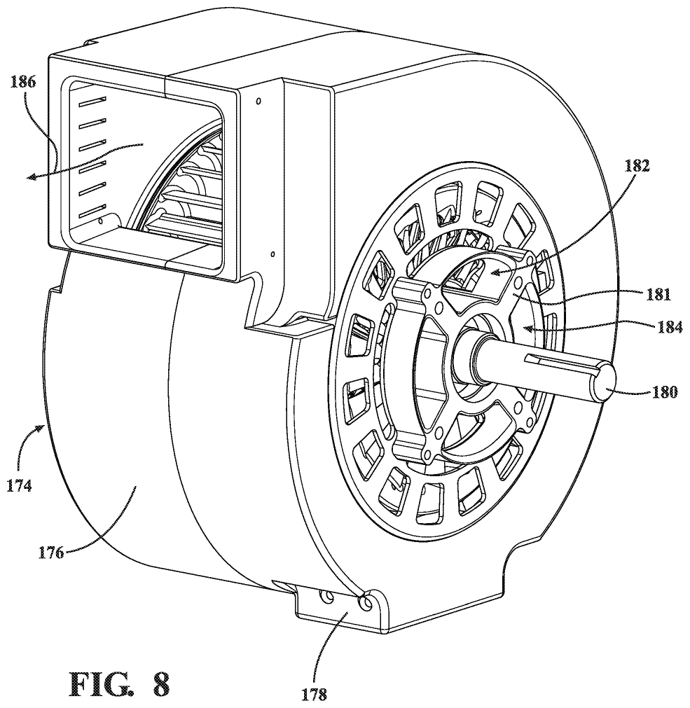

Proceeding to FIG. 8, a perspective illustration is depicted at 174 of an electromagnetic or magnetic induction furnace, cooler or magnetocaloric fluid heat pump similar in respects to FIG. 5 and according to a third embodiment of the present invention. The assembly 174 again includes a blower style body or housing 176 supported upon a pedestal base 180 and with a shaft 180 extending into a side location of the housing and positioned within a covering plate 181 which defines side air intake locations 182, 184, et seq. The housing again includes a fluid outlet 186.

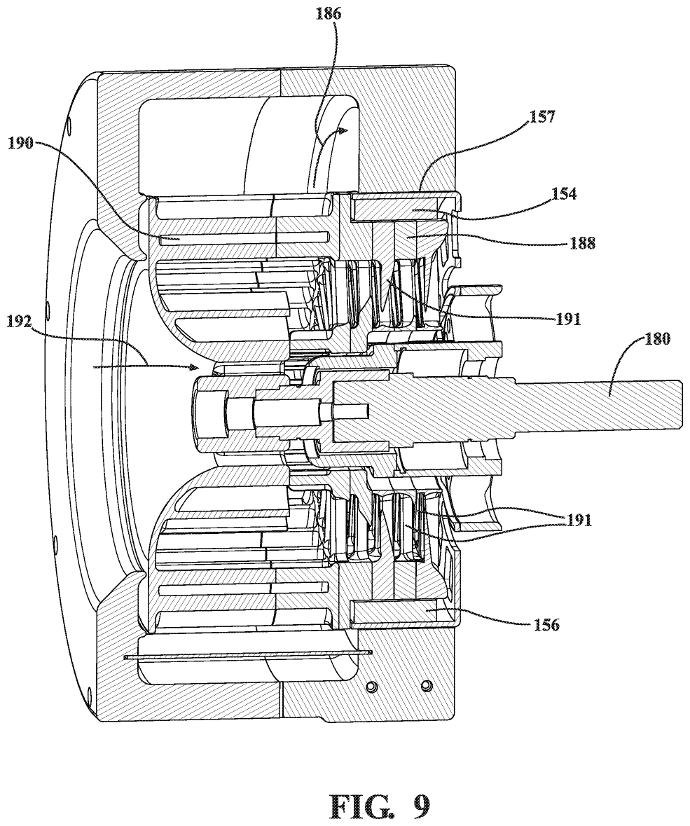

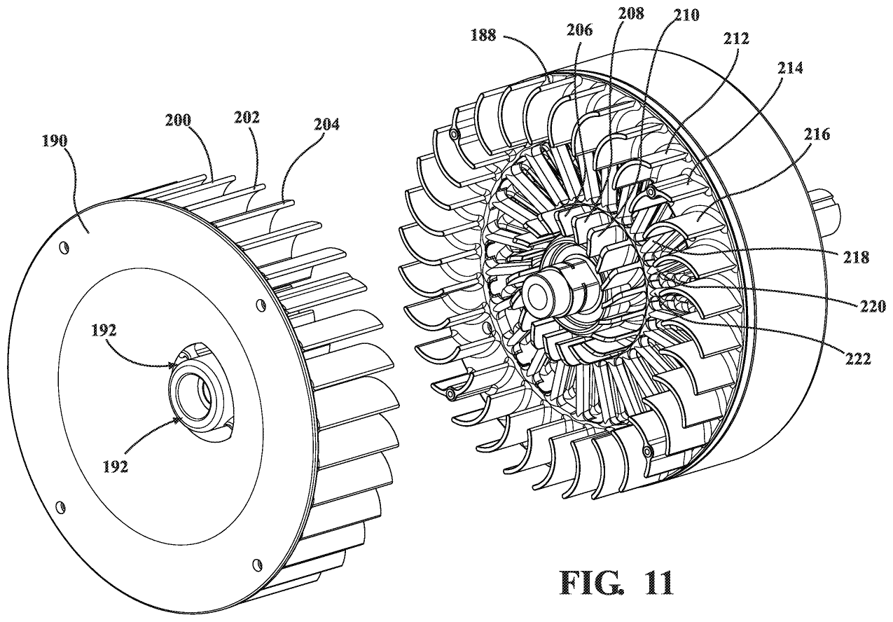

FIG. 9 is a perspective cutaway view similar to as shown in FIG. 7 and depicting the assembly of FIG. 8 with a central rotating conductive fan or plate assembly (see core component 188 and axial end connected component 190) surrounded by the fixed magnet/electromagnet array, again at 154/156 which are supported upon an inner circumferential surface of an annular shell 157. The conductive fan array includes the inner core 188 including each of an outer radial magnetic flux heated metal/alloy or combination of metals/alloys in combination with an inner radial heat sink arrangement of fan/ribs, see at 191, for heating the intake ambient air both reflected in the side inlets of FIG. 8 (182/184) as well as at intake locations 192 as shown in FIGS. 9 and 11 prior to outputting through the outlet 186.

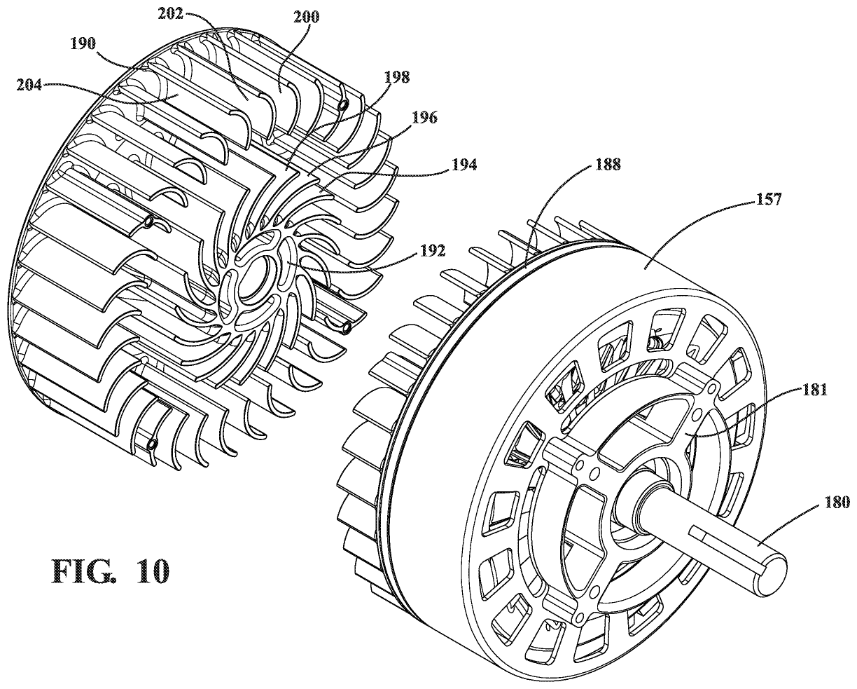

FIG. 10 is an exploded view of the first 188 (core) and second 190 (axially joined) assembleable components of the conductive plate of FIG. 9 and showing the nesting arrangement established between the inner and outer fluid redirecting vane patterns associated with each component. As best shown in FIG. 10, the axially joined rotating conductor portion 190 includes central admittance apertures 192 for receiving the inlet air stream 192 from FIG. 9. A first plurality of arcuately shaped and circumferentially spaced vanes are depicted at 194, 196, 198, et seq., extending from intermediate locations of the support plate associated with the axially joined portion 190. A second outer plurality of arcuately shaped and circumferentially spaced vanes are depicted at 200, 202, 204, et seq. positioned outward of the inner plurality of vanes, the second outer plurality of vanes exhibiting an opposite curvature in order to assist in baffling the intake airflows into the rotating conductive fan component.

FIG. 11 is a rotated exploded perspective of FIG. 10 and further depicting from another angle the nesting arrangement established between the inner and outer fluid redirecting vane patterns associated with each component, and in particular the superheated core component 188 of the rotating conductive fan unit. As shown, the vane configuration of the core component 188, opposing that described in reference to the axially joined conductive fan component 190 in FIG. 10, further includes an inner plurality of extending and circumferentially arrayed vanes 206, 208, 210, et seq., in combination with an outer radial plurality of extending and circumferentially spaced apart vanes 212, 214, 216, et seq. The outer vanes again exhibit an opposite curvature to the inner vanes as with those depicted in the laterally joined component 190 in FIG. 10. As further shown in FIG. 11, the outer vane array of the core component 188 is spaced via a plurality of radial ribs 218, 220, 222, et seq. from the inner plurality of vanes 206, 208, 210, et seq.

In combination with the assembled view of FIG. 9, assembly of the rotating fan components 188 and 190 includes the inner circumferential array of vanes 206, 208, 210, et seq. of the core (superheated) component 188 nesting inside of the inner vane array 194, 196, 198, et seq. of the axially joined component 190. The outer vanes 212, 214, 216 of the core component 188 further align and mate with the vanes 200, 202, 204, et seq. to provide a consistent redirection flow of the intake air/fluid. As further previously described, the structure of the rotating conductive fan (again joined components 188/190) provides the aspects of providing effective inductive heating of the intake airflows from the opposite sides of the blower housing via its unique inter-connecting vane structures.

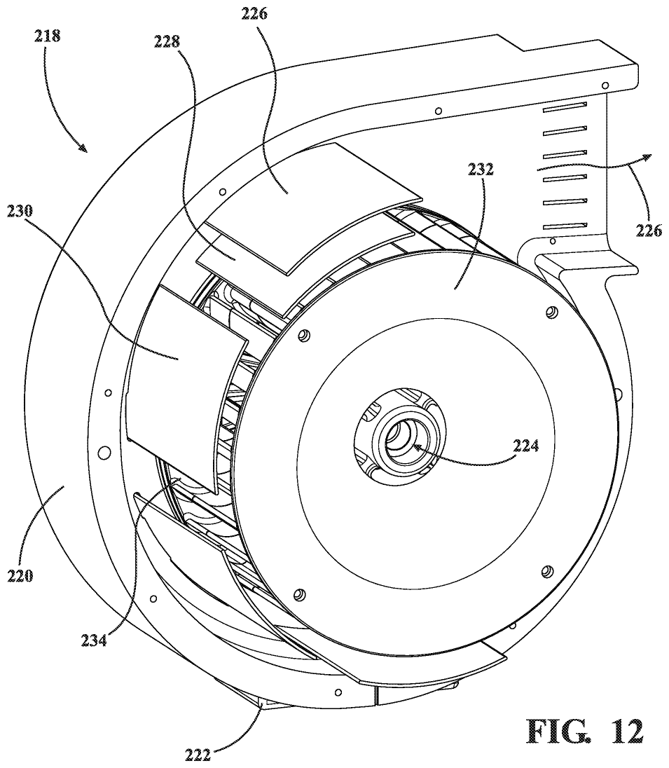

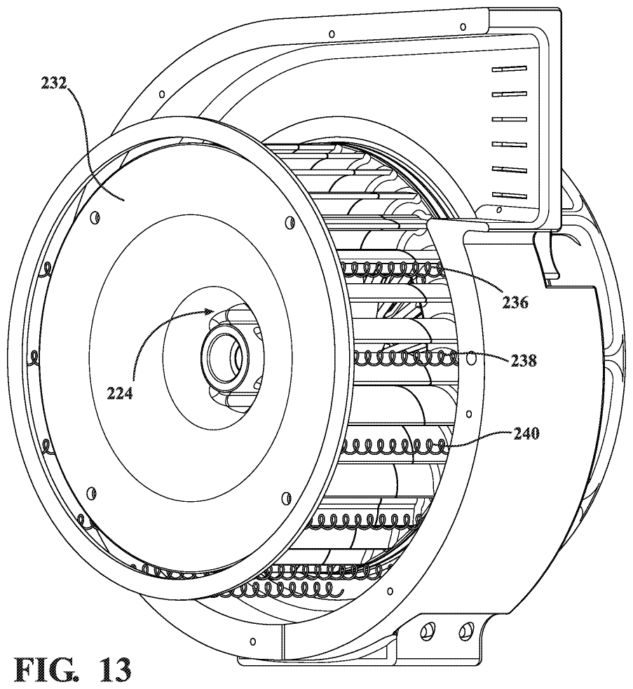

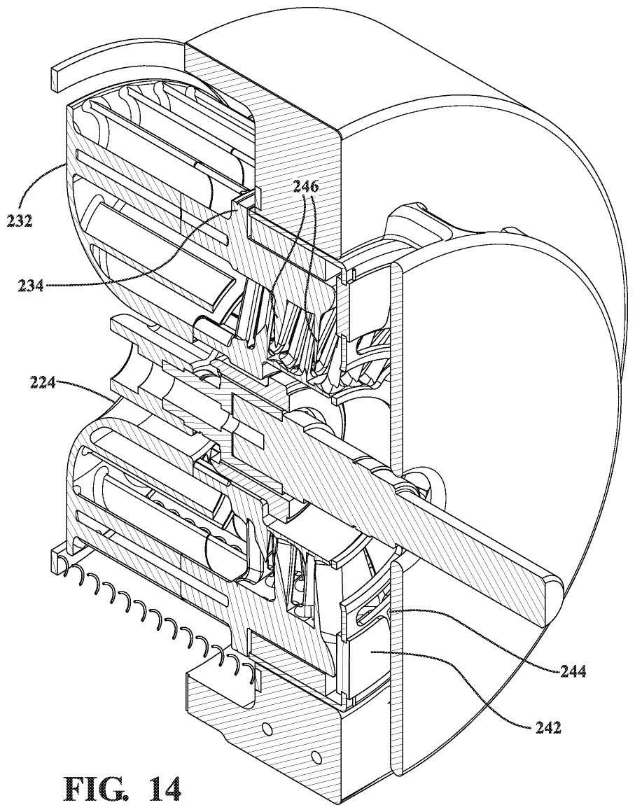

FIG. 12 is a partially cutaway perspective, at 218, of a further version of an electromagnetic or magnetic induction furnace, or cooler or magnetocaloric fluid heat pump according to a fourth embodiment of the present invention and, in combination with succeeding FIGS. 13-14. As with previous embodiments, the assembly includes a blower style housing 220 supported upon a pedestal base 222 with side inlets (see at 224).

Also depicted is an outer array of circulation baffles, see at 226, 228, 230, et seq., these configured around a corresponding axial joining component forming a portion of the rotating conductive array (see plate 232) for assisting in controlling both an outlet velocity and convection heat profile of the fluid within the housing. A core component 234 of the rotating conductive fan is further joined to the axial mating component 232 in similar fashion to that previously described, with each of joining components incorporating a similar opposing arrangement of vanes as described in the previous embodiments of FIGS. 6, 7 and 9.

FIG. 13 is a rotated perspective as compared to FIG. 12 and depicting a modified variant incorporating a plurality of circumferentially arrayed resistor coils, see at 236, 238, 240, et. seq., which are mounted in parallel arrayed proximity to the mating vanes of the components 232/234, and for providing additional thermal input (typically pre-heating) prior to the conductive plates achieving a desired thermal profile temperature. The resistor coils can be arrayed horizontally, vertically, in perimetral or radial distribution following a circumferential, polygonal or any other type of geometrical shape. Without limitation, the coils can be connected to an electrical input source (not shown) and, once utilized to pre-heat the conductive plates, can be disconnected or shut off to allow regular inductive heating to proceed owing to the inter-rotation established between the conductive plates and the magnets/electromagnets (not shown in this view but similarly arranged as again shown at 154/156 in FIG. 9)

FIG. 14 is a rotated perspective of FIG. 13 with additional components removed and showing a configuration of Peltier elements or other thermoelectric generators, see at 242, 244, et seq., incorporated into the housing proximate the magnets/electromagnets and the superheated thermally conductive metal/alloy core of the rotating conductive and fluid redirecting elements, such including thermoelectric coolers (TEC' s) for transferring heat from one side to another depending on the direction of an applied electrical current. The rotating conductive fan, as again provided by core component 234 and axially joined component 232, can again be provided as separate materials which are designed and assembled in a manner to enhance the generation of eddy currents during operation and in order to maximize a desired thermal profile resulting from the inductive heating or magnetocaloric cooling operation. The core component 234 additionally includes a redesigned vane structure, see at 246, for channeling and redirecting the heated air to the eventual outlet 226.

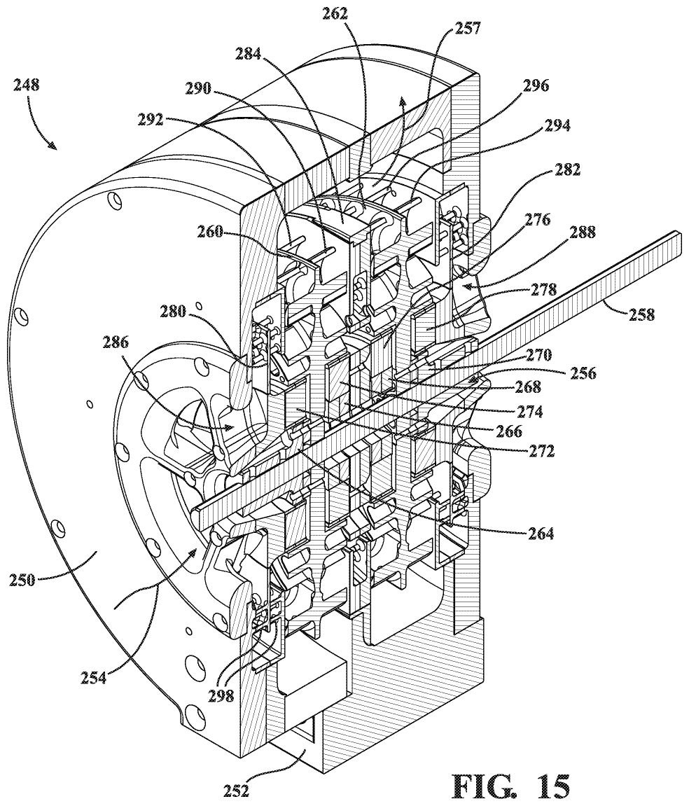

FIG. 15 a cutaway perspective of an electromagnetic or magnetic induction furnace, cooler or magnetocaloric fluid heat pump according to a fifth embodiment, see generally at 248, which is similar to that previously shown in the initial embodiment of FIGS. 2-3. As with previously embodiments, a housing 250 is supported upon a pedestal base 252 and includes inlet locations on each of opposite sides (see at 254 and 256) along with an upper outlet 257. A shaft 258 (such as motor powered as in FIG. 1) extends within the interior of the housing 250 and in order to operate a dual rotating conductive plate array, see at 260 and 262, which are provided in combination with magnet/electromagnet supporting plates 264, 266, 268 and 270. Each of the plates 264-270 are secured to locations within the housing and each further exhibits a central aperture through which the rotating shaft 258 extends.

As further shown, the plates each further incorporate a circumferential spaced plurality of magnets/electromagnets, respectively shown at 272, 274, 276 and 278. Without limitation, the configuration and material selection for each of the magnetic and electromagnetic plates can again be selected from any material not limited to rare earth metals and alloys and which possesses properties necessary to generate adequate oscillating magnetic fields for inducing magnetic heating or cooling, such again resulting from the ability to either maintain or switch the magnet/electromagnet polarity at a sufficiently high rate in order for the generated friction to create the desired heat/cold profile. The conductive plates can be constructed of a ferromagnetic, ferrimagnetic, antiferromagnetic, paramagnetic or diamagnetic material and, as understood, do not generate magnetic fields but are based on electromagnetic or magnetic induction such that they create eddy currents.

A pair of outer end intake components 280 and 282 are depicted in combination with a central intake warmer component 284. The end intake components 280/282 each exhibit a reverse angled redirection passageway, see at 286 and 288 for end intake components 280 and 282, for preheating the intake fluid/air prior to the same being redirected by the rotating conductive plates 260/262.

Each of the conductive plates further incorporates a plurality of arcuate shaped redirecting vanes, see at 290, 292, et seq., for plate 260 and further at 294, 296 et seq., for plate 262 and which are depicted as arranged in circumferentially spaced and projecting fashion from each opposite surface of each of the plates 260/262 (as previously with plates 36/38 in FIG. 2). In combination with the other features of the conductive plates, the vanes again operate during rotation of the conductive plates to influence (push) the inductive heated air generated in the spaces between the magnet/electromagnetic array and the rotating conductive plates resulting from the frictional heat generating forces resulting from varying/oscillating magnetic fields for delivery through the outlet 257 of the blower style housing.

In this manner, the core of the individual rotating plates 260/262 are caused to become heated (or superheated) to a desired temperature due to their positioned relationship with pairs of the individual magnet/electromagnet supporting plates 264/266, and 268/270, the cores in turn heating the intake fluid/air for concurrent redirection via the circumferential arranged vanes through the outlet 257.

As further shown, each of the end intake components 280/282 and central intake component 284 include pluralities of fluid flow interrupting and baffling components, see at as shown at 298 for selected intake component 280, which operate to interrupt the intake fluid flows 286/288 to allow for more controlled fluid passageway and resultant inductive heating prior to discharge by the rotating conductive elements through the outlet 257.

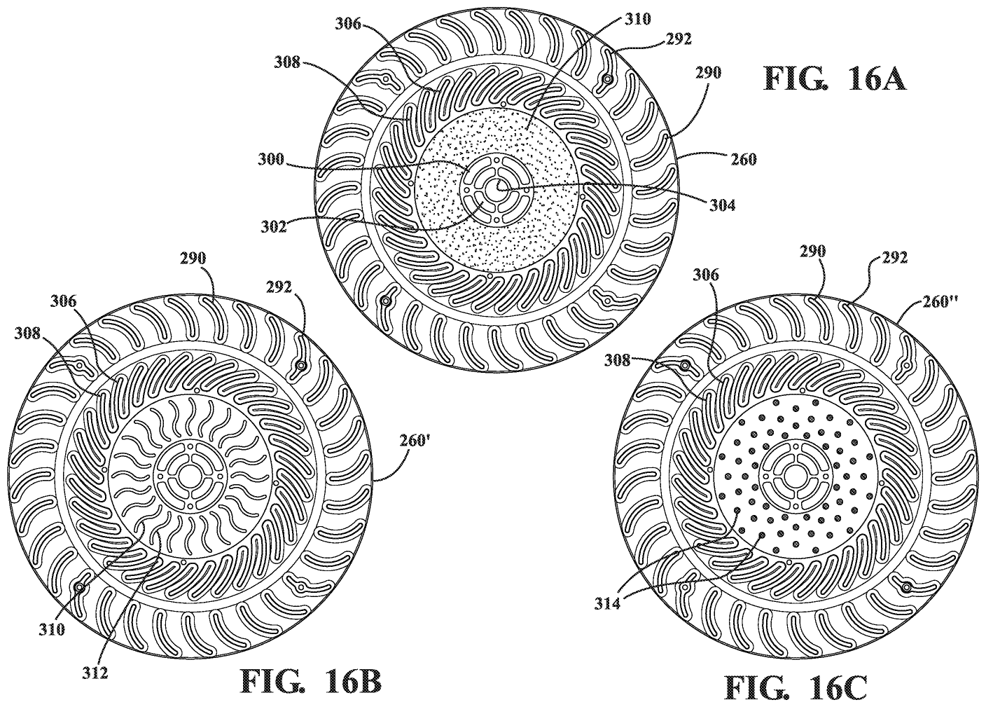

FIGS. 16A-16C present a series of cutaway sectional views of alternate versions of a core portion of the rotating conductive plates of taken along line 16-16 of FIG. 15 and which depict varying patterns of bi-metal/bi-alloy or multi-metal/multi-alloy designs. As will be described below, each of the conductive plate designs depict a varying combination of fluid flow redirecting and thermal eddy current generating configurations and which can utilize any of the material compositions or configurations shown in the prior examples of FIGS. 4A-4D.

FIG. 16A illustrates a first example of plate 260 in FIG. 15 and including an arrangement of interior heated air communicating apertures 300, 302, et seq. (via inlets 254/256) which surround a central aperture 304 for receiving the drive shaft 258. The outer array of vanes is again depicted at 290, 292, et seq. extending around the circumference of the plate and projecting in each of opposite directions as shown in FIG. 15. In combination with the outer vanes, an additional plurality of inner circumferential vanes 306, 308, et seq. are shown which arcuately shaped in a reverse direction and which assist in providing counter directional baffling of the fluid as it is communicated through the side inlets, progressively inductive heated (or magnetocaloric cooled) and then exited through the outlet. A further central most area 310 is depicted which can include a textured composition of any thermal conductive material such as provided in combination with a conductive material construction of the main conductor plate.

FIG. 16B illustrates a variation 260′ of the conductive plate which is largely similar to that shown in FIG. 16A with a similar arrangement of outer 290, 292, et seq. and inner 306 306, et seq. arrangement of circumferentially arrayed vanes. An additional array of secondary thermal conductive material inserts are depicted at 310, 312, et seq. and which are configured across the central surface area of the disk body around the central apertures.

FIG. 16C illustrates a further example 260′ of conductive plate which differs from those shown in FIGS. 16A and 16B only in the configuration of the secondary thermal conductive metal distributed across its central most area and depicted by small disk-shaped elements 314. Without limitation, the features described in FIGS. 16A-16C are understood to be applicable to any planar surface or perimetral surface associated with any conductive plate construction.

As previously described, other and additional envisioned applications can include adapting the present technology for use in magnetocaloric heat pump (MHG) applications, such utilizing a magneto-caloric effect (MCE) provide either of heating or cooling properties resulting from the magnetization (heat) or demagnetization (cold) cycles. The goal in such applications is to achieve a coefficient of performance (defined as a ratio of useful heating or cooling provided to work required) which is greater than 1.0. In such an application, the system operates to convert work to heat as well as additionally pumping heat from a heat source to where the heat is required (and factoring in all power consuming auxiliaries). As is further known in the relevant technical art, increasing the COP (such as potentially to a range of 2.0-3.5 or upwards) further results in significantly reduced operating costs in relation to the relatively small input electrical cost required for rotating the conductive plate(s) relative to the magnetic plate(s). Magnetic refrigeration techniques result in a cooling technology based on the magneto-caloric effect and which can be used to attain extremely low temperatures within ranges used in common refrigerators, such as without limitation in order to reconfigure the present system as a fluid chiller, air cooler, active magnetic regenerator or air conditioner.

As is further known in the relevant technical art, the magneto-caloric effect is a magneto-thermodynamic phenomenon in which a temperature change of a suitable material is again caused by exposing the material to a changing magnetic field, such being further known by low temperature physicists as adiabatic (defined as occurring without gain or loss of heat) demagnetization. In that part of the refrigeration process, a decrease in the strength of an externally applied magnetic field allows the magnetic domains of a magneto-caloric material to become disoriented from the magnetic field by the agitating action of the thermal energy (phonons) present in the material.

If the material is isolated so that no energy is allowed to (re)migrate into the material during this time, (i.e., again the adiabatic process) the temperature drops as the domains absorb the thermal energy to perform their reorientation. The randomization of the domains occurs in a similar fashion to the randomization at the curie temperature of a ferromagnetic, ferrimagnetic, antiferromagnetic, paramagnetic or diamagnetic material, except that magnetic dipoles overcome a decreasing external magnetic field while energy remains constant, instead of magnetic domains being disrupted from internal ferromagnetism, ferrimagnetism, antiferromagnetism, (or either of paramagnetism/diamagnetism) as energy is added. Applications of this technology can include, in one non-limited application, the ability to heat a suitable alloy arranged inside of a magnetic field as is known in the relevant technical art, causing it to lose thermal energy to the surrounding environment which then exits the field cooler than when it entered.

Other envisioned applications include the ability to generate heat for conditioning any fluid (not limited to water) utilizing either individually or in combination rare earth magnets placed into a high frequency oscillating magnetic field as well as static electromagnetic field source systems including such as energized electromagnet assemblies which, in specific instances, can be combined together within a suitable assembly not limited to that described and illustrated herein and for any type of electric induction, electromagnetic and magnetic induction application. It is further envisioned that the present assembly can be applied to any material which is magnetized, such including any of diamagnetic, paramagnetic, and ferromagnetic, ferrimagnetic or antiferromagnetic materials without exemption also referred to as magnetocaloric materials (MEMs).

Additional factors include the ability to reconfigure the assembly so that the frictionally heated fluid existing between the overlapping rotating magnetic and stationary fluid communicating conductive plates may also include the provision of additional fluid mediums (both gaseous and liquid state) for better converting the heat or cooling configurations disclosed herein. Other envisioned applications can include the provision of capacitive and resistance (ohmic power loss) designs applicable to all materials/different configurations as disclosed herein.

The present invention also envisions, in addition to the assembly as shown and described, the provision of any suitable programmable or software support mechanism, such as including a variety of operational modes. Such can include an Energy Efficiency Mode: step threshold function at highest COP (at establish motor or other rotary inducing input drive rpm) vs Progressive Control Mode: ramp-up curve at different rpm/COPs).

Other heat/cooling adjustment variables can involve modifying the degree of magnetic friction created, such as by varying the distance between the conductive fluid circulating disk packages and alternating arranged magnetic/electromagnetic plates. A further variable can include limiting the exposure of the conductive fluid (gas, liquid, etc.,) to the conductive component/linearly spaced disk packages, such that a no flow condition may result in raising the temperature (and which can be controllable for certain periods of time).

As is further generally understood in the technical art, temperature is limited to Curie temperature, with magnetic properties associated with losses above this temperature. Accordingly, rare earth magnets, including such as neodymium magnets, can achieve temperature ranges upwards of 900° C. to 1000° C.

Ferromagnetic, ferrimagnetic, antiferromagnetic, paramagnetic or diamagnetic materials, such as again which can be integrated into the conductive plates, can include any of Iron (Fe) having a Curie temperature of 1043K (degrees Kelvin), Cobalt (Co) having a Curie temperature of 1400K, Nickel (Ni) having a Curie temperatures of 627K and Gadolinium (Gd) having a Curie temperature of 292K.

According to these teachings, Curie point, also called Curie Temperature, defines a temperature at which certain magnetic materials undergo a sharp change in their magnetic properties. In the case of rocks and minerals, remanent magnetism appears below the Curie point—about 570° C. (1,060° F.) for the common magnetic mineral magnetite. Below the Curie point—by non-limiting example, 770° C. (1,418° F.) for iron—atoms that behave as tiny magnets spontaneously align themselves in certain magnetic materials.

In ferromagnetic materials, such as pure iron, the atomic magnets are oriented within each microscopic region (domain) in the same direction, so that their magnetic fields reinforce each other. In antiferromagnetic materials, atomic magnets alternate in opposite directions, so that their magnetic fields cancel each other. In ferrimagnetic materials, the spontaneous arrangement is a combination of both patterns, usually involving two different magnetic atoms, so that only partial reinforcement of magnetic fields occurs.

Given the above, raising the temperature to the Curie point for any of the materials in these three classes entirely disrupts the various spontaneous arrangements, and only a weak kind of more general magnetic behavior, called paramagnetism, remains. As is further known, one of the highest Curie points is 1,121° C. (2,050° F.) for cobalt. Temperature increases above the Curie point produce roughly similar patterns of decreasing paramagnetism in all three classes of materials such that, when these materials are cooled below their Curie points, magnetic atoms spontaneously realign so that the ferromagnetism, antiferromagnetism, or ferrimagnetism revives. As is further known, the antiferromagnetic Curie point is also referenced as the Neel temperature.

Other factors or variable controlling the temperature output can include the strength of the magnets/electromagnets which are incorporated into the plates, such as again by selected rare earth magnets having varying properties or, alternatively, by adjusting the factors associated with the use of electromagnets including an amount of current through the coils, adjusting the core ferromagnetic properties (again though material selection) or by adjusting the cold winding density around the associated core.

Other temperature adjustment variables can include modifying the size, number, location and orientation of the assemblies (elongated and plural magnet/electromagnet and alternative conductive plates). Multiple units or assemblies can also be stacked, tiered or otherwise ganged in order to multiply a given volume of conditioned fluid which is produced.

Additional variables can include varying the designing of the conductive disk packages, such as not limited varying a thickness, positioning or configuration of a blade or other fluid flow redirecting profile integrated into the conductive plates, as well as utilizing the varying material properties associated with different metals or alloys, such including ferromagnetic, ferrimagnetic, antiferromagnetic, paramagnetic and diamagnetic properties.

Having described my invention, other and additional preferred embodiments will become apparent to those skilled in the art to which it pertains, and without deviating from the scope of the appended claims. The detailed description and drawings are further understood to be supportive of the disclosure, the scope of which being defined by the claims. While some of the best modes and other embodiments for carrying out the claimed teachings have been described in detail, various alternative designs and embodiments exist for practicing the disclosure defined in the appended claims.

The foregoing disclosure is further understood as not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosure. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

I claim:

1. An air or fluid conditioning system, comprising:
a housing within a fluid inlet and a fluid outlet;
a rotating shaft extending within said housing and securing a conductive component exhibiting fluid flow redirecting vanes for communicating an inlet fluid flow with an outlet fluid flow;
magnets or electromagnets arranged in a stationary array within said housing in proximity to said rotary conductive component; and
upon rotating said conductive component relative to said magnetic plates, thermal conditioning of the fluid flow being generated from creation of high frequency oscillating magnetic fields and being conducted through said rotating component for outputting through the outlet of said housing.

2. The system as described in claim 1, said fluid flow redirecting vanes of said rotating conductive component further comprising a first inner plurality of circumferentially arrayed vanes and a second outer plurality of circumferentially arrayed vanes.

3. The system as described in claim 1, further comprising a motor or other rotary inducing input for rotating said shaft.

4. The system as described in claim 1, further comprising fluid flow regulating baffles to disrupt continuous movement of airflow within said rotating conductive component during thermal conditioning and prior to exiting through said outlet.

5. The system as described in claim 1, said rotating conductive component further comprising first and second spaced apart plates alternating with said magnets or electromagnets.

6. The system as described in claim 1, said rotating conductive component further being constructed of a first thermally conductive material and comprising a superheated core portion arranged closest to said magnets or electromagnets.

7. The system as described in claim 5, said core portion further comprising a plurality of inserts of a second thermally conductive material interspersed with said first thermally conductive material in order to promote the occurrence of eddy currents in order to facilitate the creation of the high frequency oscillating magnetic fields.

8. The system as described in claim 5, said fluid inlet further comprising a pair of opposite side located inlets, a pair of end intake fluid warming component arranged in proximity to said side inlets prior to communicating the fluid flow to the spaced apart plates.

9. The system as described in claim 5, said fluid inlet further comprising a plurality of slot shaped inlets extending circumferentially around a middle location of said housing, a center intake fluid warming component arranged in proximity to said slot shaped inlets prior to communicating the fluid flow to the spaced apart plates.

10. The system as described in claim 7, said first thermally conductive material further comprising any metal or alloy, ceramic or any metal-ceramic composite material or graphite or combination of such conductive materials.

11. The system as described in claim 9, said second thermally conductive material further comprising any metal or alloy, ceramic or any metal-ceramic composite material or graphite or combination of such conductive materials.

12. The system as described in claim 11, said rotating conductive component further comprising a core portion opposing said magnet or electromagnet array, said conductive component further comprising a second axial portion secured to said core portion.

13. The system as described in claim 12, said fluid flow redirecting vanes further comprising opposing pluralities of said vanes arranged upon each of said core portion and said axially secured portion.

14. The system as described in claim 12, said core portion further comprising any of a magnetic flux heated metal/alloy or combination of metals/alloys.

15. The system as described in claim 12, further comprising a plurality of heat sink inducing ribs integrated into said core portion in proximity to the fluid inlet.

16. The system as described in claim 12, further comprising elongated and thermal resistor coils extending in any of horizontally, vertically, perimetral, or radial distributing fashion within said housing and across said core portion and axially secured portion, said coils following any of circumferential, polygonal, or other geometrical shape.

17. The system as described in claim 1, further comprising a combined layering electric induction heating and magnetic induction heating to accelerate a pre-heating operation.

18. The system as described in claim 4, further comprising said fluid flow regulating baffles extending around said fluid flow redirecting vanes.

19. The system as described in claim 1, further comprising Peltier or other thermoelectic generator elements incorporated into said housing.

20. The system as described in claim 1, said housing further comprising a pseudo cylindrical shape supported upon a pedestal portion.

21. A fluid conditioning system, comprising:
a housing within a fluid inlet and a fluid outlet;
a rotating shaft extending within said housing and securing a conductive component exhibiting fluid flow redirecting vanes for communicating an inlet fluid flow with an outlet fluid flow;
magnets or electromagnets arranged in a stationary array within said housing in proximity to said rotary conductive component;
said rotating conductive component further being constructed of a first thermally conductive material and comprising a superheated core portion arranged closest to said magnets or electromagnets;
said core portion further including a plurality of inserts of a second thermally conductive material interspersed with said first thermally conductive material in order to promote the occurrence of eddy currents in order to facilitate the creation of the high frequency oscillating magnetic fields and in order to operate as fan/fluid propeller for influencing fluid flow through said outlet; and
upon rotating said conductive component relative to said magnetic plates, thermal conditioning of the fluid flow being generated from creation of high frequency oscillating magnetic fields and being conducted through said rotating component for outputting through the outlet of said housing.
